(19) United States
(12) Patent Application Publication
(10) Pub. No.: US 2003/0088644 A1
(43) Pub. Date: May 8, 2003

(54) Method and system for providing a virtual user interface

(75) Inventors: Deb Dutta Ganguly, Brookline, MA (US); Prakash Khot, Burlington, MA (US); Jayant Pandit, Ottawa (CA); Rutvik Doshi, Framingham, MA (US)

Correspondence Address: Calfee, Halter & Griswold LLP, Suite 1650, 21 East State Street, Columbus, OH, 43215-4243, US

(73) Assignee: Computer Associates Think, Inc.

(21) Appl. No.: 10/190,944

(22) Filed: Jul. 8, 2002

Related U.S. Application Data
(60) Provisional application No. 60/303,448, filed on Jul. 6, 2001.

(51) Int. Cl. G06F 15/16

(52) U.S. Cl. 709/218

(57) ABSTRACT

A method is provided for monitoring interaction associated with an application. The method includes configuring recording, playback and analysis parameters, and recording control flow and server responses associated with the application. The method also includes replaying the control flow and comparing server responses to the replayed control flow to recorded server responses to determine whether an alert condition exists. The method further includes reporting the alert condition. Systems and articles of manufacture are also provided to implement the described methods.

### CROSS-REFERENCE TO RELATED APPLICATIONS

This application claims priority to U.S. Provisional Application Serial No. 60/303,448, filed Jul. 6, 2001, the entirety of which is hereby incorporated by reference.

### TECHNICAL FIELD

The present application generally relates to information and data management systems and methods. The present application more specifically relates to Information Techonology monitoring.

### BACKGROUND

Many information and service providers enable users to access information and services via a client-server architecture, for example using web-based applications written in languages such as Java. Many of the functions performed by such applications are routine functions that a user may periodically request, such as checking a balance of a checking account or making a minimum payment to a credit card account, for example.

Presently, each time that a user wishes to perform one of these routine functions, the user must request the function to be performed and provide all of the input for the function to be performed. This is true even in cases where the input is standardized and does not vary from request to request.

Repeatedly requesting the same information from the user to accomplish a previously requested function is an inefficient use of the user's time. Some web-based applications have addressed this inefficiency by providing a capability to store user preferences. Such functionality, however, is only available sporadically, for specific web applications, namely, those applications which have been designed to include a feature of storing and recalling user preferences.

Consequently, a need exists for a system and method for reducing the amount of time and effort a user must provide to submit routine, periodic requests for information or services. Further, a need exists for a solution which is compatible with existing client-server applications.

### SUMMARY

The following presents a simplified summary of methods, systems, and computer readable media associated with recording and replaying interaction associated with a client-server application, thereby providing a virtual user interface. This summary is not an extensive overview and is not intended to identify key or critical elements of the methods, systems, and/or media or to delineate the scope of the methods, systems, and media. It conceptually identifies the methods, systems, and media in a simplified form as a prelude to the more detailed description that is presented later.

This disclosure provides methods and systems for monitoring interaction associated with a client server application in a computer processing environment. According to one aspect of the disclosure, a method for monitoring interaction associated with a client-server application is disclosed. The method includes configuring recording, playback and analysis parameters. The method also includes recording control flow and server responses associated with the application. The method further includes replaying the control flow, and comparing responses received from the server to the replayed control flow to recorded server responses to determine whether an alert condition exists. The alert condition is processed according to the configured analysis parameters.

A system for monitoring interaction associated with an application is also disclosed. In one embodiment, the system includes a configuration module for defining and storing configuration data. The system also includes a recording module for monitoring client-server interaction of the application. The recording module is further operative to store control flow data representing the monitored client-server interaction. The system further includes a playback module. The playback module is operative to replay client portions of the stored control flow data and to analyze server responses to determine and report an alert. In addition, the system includes a control module for controlling the configuration module, the recording module and the playback module.

Computer-readable storage media are also disclosed which include processing instructions for implementing certain disclosed methods.

Certain illustrative aspects of the methods, systems, and computer readable media are described herein in connection with the following description and the annexed drawings. These aspects are indicative, however, of but a few of the various ways in which the principles of the methods, systems, and media may be employed and thus the examples are intended to include such aspects and equivalents. Other advantages and novel features may become apparent from the following detailed description when considered in conjunction with the drawings.

### BRIEF DESCRIPTION OF THE DRAWINGS

For a more complete understanding of the present methods and systems, reference is now made to the following description taken in conjunction with the accompanying drawings in which like reference numbers indicate like features and wherein:

FIG. 1 is a schematic block diagram of an example interaction recording system;

FIG. 2 is a flow chart that illustrates an example methodology for employing the interaction recording system of FIG. 1;

FIG. 3 is an initial window of an exemplary embodiment the present application;

FIG. 4 is a “New Instance” window of the exemplary embodiment the present application;

FIG. 5 is a control flow recording window of the exemplary embodiment the present application;

FIGS. 6A-6G are various windows presented according to a step-adding wizard for the exemplary embodiment the present application; and

FIGS. 7A-7D are various windows enabling method validation configuration for the exemplary embodiment the present application.

### DETAILED DESCRIPTION

Example methods, systems, and computer readable media are now described with reference to the drawings, where like reference numerals are used to refer to like elements throughout. In the following description, for purposes of explanation, numerous specific details are set forth in order to facilitate thoroughly understanding the methods and systems. It may be evident, however, that the methods and systems can be practiced without these specific details. In other instances, well-known structures and devices are shown in block diagram form in order to simplify the description.

The present application augments traditional Information Technology management solutions by providing the ability to record, replay and analyze interaction between a user and an application. In one embodiment, such interaction may represent business logic occurring within a client-server application. Although the exemplary system is described with respect to a client-server architecture, other architectures may be utilized, such as a peer to peer architecture, for example.

The present application describes an exemplary client-server interaction recorder/player (“Interaction Recorder”) which employs a user-friendly wizard-based interface to create a virtual user. The exemplary Interaction Recorder uses the virtual user to simulate a human user interacting with Enterprise java Beans (“EJB's”). One or more virtual users then interact periodically with an associated client-server application to analyze whether the interaction or business logic is performing according to specification. The analysis is described as being performed at 3 levels: application response time, returned values, and exceptions, but analysis at other levels are possible.

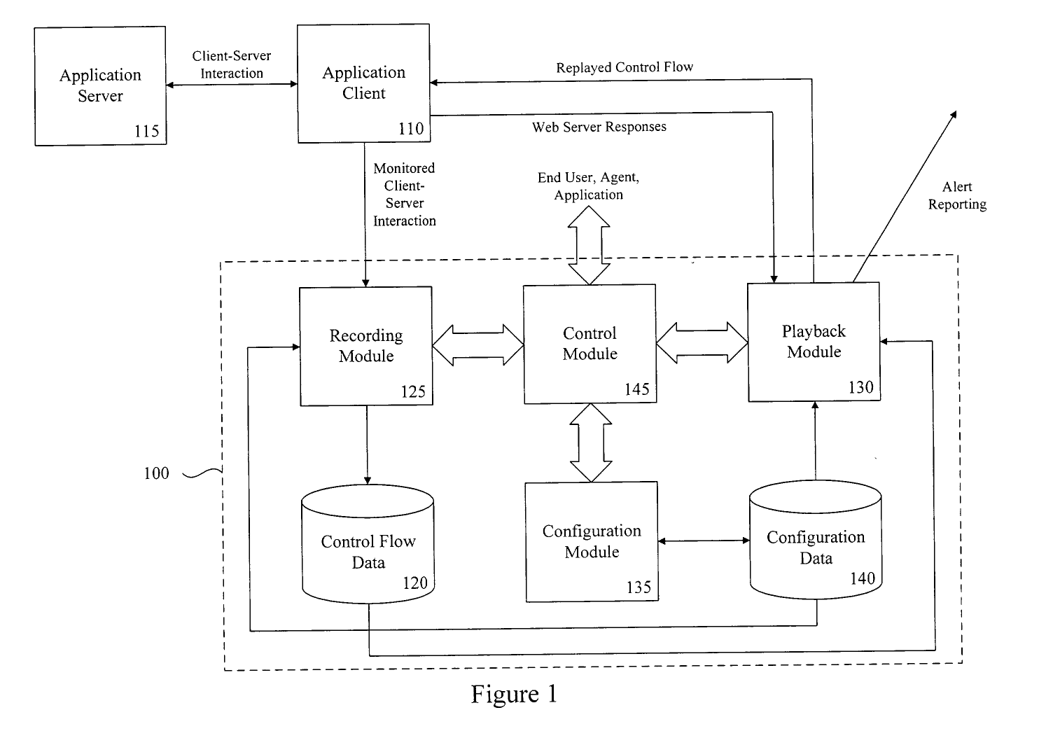

Referring to FIG. 1, there is illustrated an example interaction recording system 100 for monitoring, recording replaying and analyzing interactions between application client 110 and application server 115. The example interaction recording system 100 enables an end user or application to capture and replay interaction of an EJB client with an EJB server. The captured interaction or control flow is stored as data in store 120. The recording module 125 monitors and records the data provided by the application client 110 as well as data returned by application server 115 as control flow data. Playback module 130 enables an end user, application or intelligent agent to replay a control flow using the stored control flow data associated with the application client 110. During the process of replaying of a control flow, the responses from application server 115 are compared to the stored control flow data representing the responses originally provided by application server 115. If the stored responses are not consistent with the responses provided during the replayed control flow, playback module 130 reports an alert.

While providing other functionality, configuration module 135 enables the end user to customize the operation of the playback module 130. Configuration parameters determined by the end user are stored as configuration data in store 140 and include, for example, alert ranges and notification messae contents. Control module 145 enables an intelligent agent, end user or application to interact with the system 100 and controls the recording, playback and configuration modules.

To illustrate the utility of interaction recording system 100, consider an exemplary bank account EJB application that provides deposit, withdraw and check balance methods. A typical user interface, built using servlets, may use such methods to provide an ATM-like functionality through a standard web browser. Using the exemplary EJB application, a customer may deposit money, withdraw money and at times check the balance of the user's account. The recording module 125 can be used to record this interaction either through the web browser or directly with the EJBs.

Intelligent agents may invoke the playback module 130 to replay the recorded control flow data after a specific time interval. During playback, the playback module 130 may determine that the balance check method is returning an unexpected value. This non-conformity could result in an immediate alert message being sent to the administrator who can then check the server and or the database to see why the error occurred and take steps to correct the problem.

In one embodiment, the control module employs a simple user interface that provides wizard-based paradigms to capture the client interaction and server responses. The interface enables the end user to direct the recording of user interactions and the replaying of a recorded control flow from store 120. The interface may simulate the user's actions by repeating the control flow steps in the exact sequence originally monitored. The interface may further report the results of the server's responses and the originally recorded data.

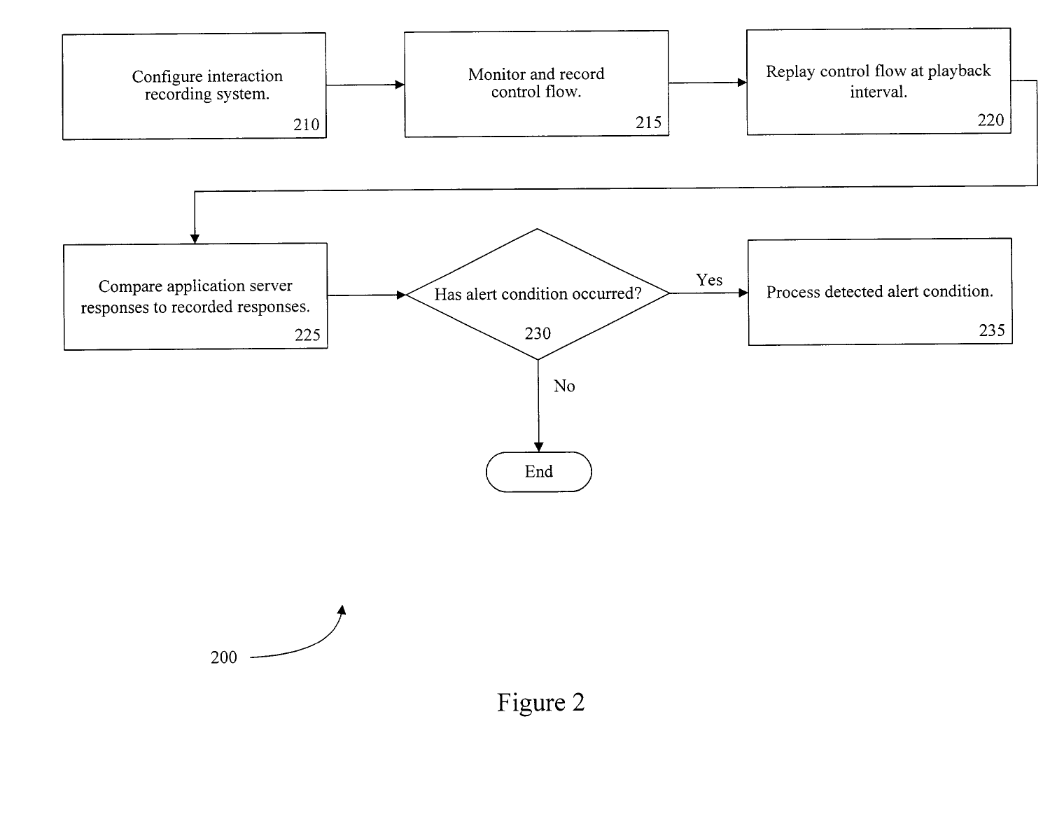

FIG. 2 illustrates one example methodology 200 that may be employed using the interaction recording system 100 of FIG. 1. At block 210, the end user configures the interaction recording system 100. Configuring the interaction recording system 100 may include, for example, defining a playback interval, defining alert conditions, and defining actions for responding to detected alert conditions.

The recording module 125 is employed at block 215 to monitor and record the control flow of a client-server application session. The monitored control flow includes the interaction between the client 110 and the server 115, and is stored as control flow data in store 110. At a predetermined playback interval, the playback module 130 is employed at block 220 to replay the control flow of the recorded session. The playback module 130 compares the responses to the replayed control data received from application server 115 to the responses stored in control flow data store 120 to determine at block 230 whether an alert condition has occurred. If an alert condition is detected, the alert condition is processed at block 235, otherwise the methodology ends.

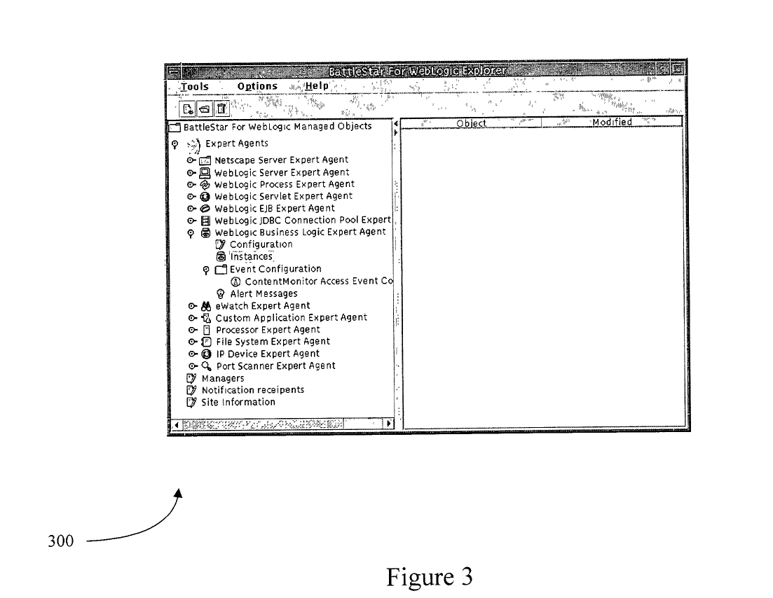

Referring now to FIGS. 3-7D, there are illustrated various example windows which may be presented to the user by the interaction recording system 100 to effect the methods and operate the systems of the present application. The exemplary system is an application designed to be executed on the BEA WebLogic Platform™ provided by BEA Systems, Inc. FIG. 3 illustrates an initial window 300 which enables the user to select expert agents. In order to begin recording a new control flow, the user selects “Instances” from the “WebLogic Business Logic Expert Agent” tree. Alternatively, the user may select “Instances” from the “Tools” menu. Selection of “Instances” enables the user to add, delete or edit stored control flow instances. Selecting “Add” enables the user to begin recording a new control flow.

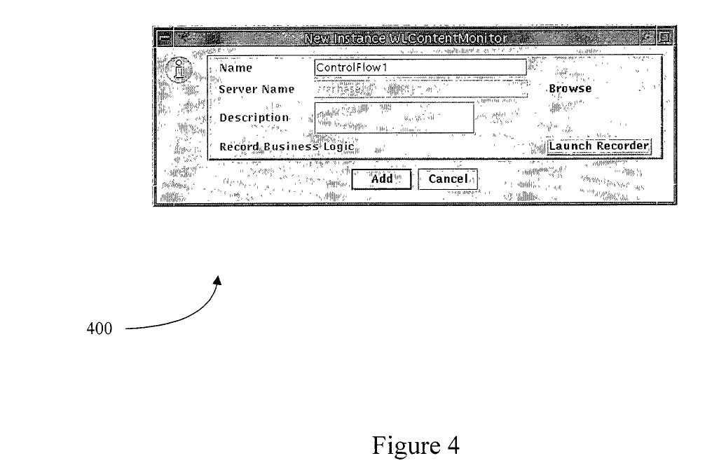

FIG. 4 depicts a “New Instance” window 400 which enables the user to define certain characteristics of the control flow to be recorded. Specifically, the user may define the name under which the control flow will be stored for future reference. The user may also provide a textual description of the control flow. In the illustrated embodiment, the server name may be selected from the WebLogic EJB servers previously configured in a database under the WebLogic Server Expert Agent. The server connection parameters, such as the URL, user name, and password are populated based on the WebLogic Server Expert Agent.

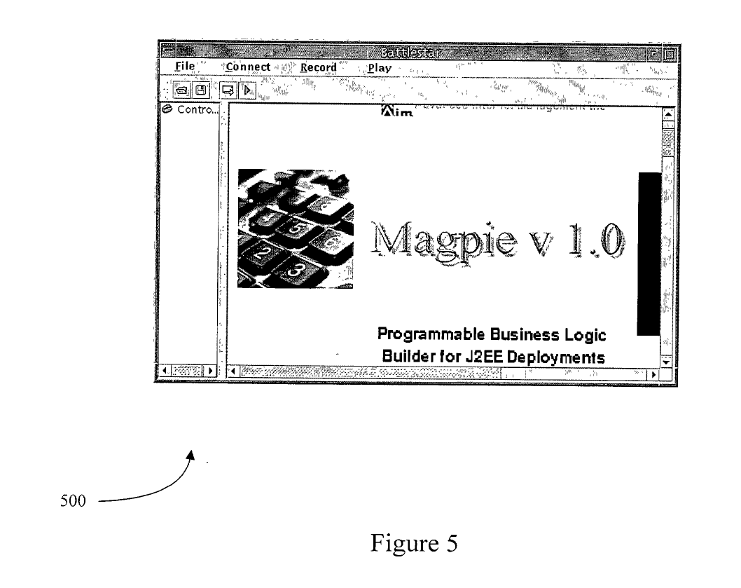

Once the characteristics of the new control flow have been defined, the user may select “Launch Recorder” to begin recording the control flow of an application session. The selection of “Launch Recorder” directs recording module 125 to establish a connection with the WebLogic EJB server and display the control flow recording window 500 depicted in FIG. 5.

The example control flow recording window employs a familiar document processing interface design augmented with additional EJB-specific options. The interface has the following menu options:

| | |
|---|---|
| File: | This option is used to access file handling functions. |
| New: | This option prompts the recording module to open a new |
| | control flow. If at the time another control flow is |
| | active, the user is prompted if the control flow should be |
| | saved or not. |
| Open: | This option prompts the playback module to open a |
| | prerecorded control flow. |
| Save: | This option saves the currently active control flow under |
| | its current name. |
| Save as: | This option saves the currently active control flow under |
| | a different name. |
| Exit: | This option closes the interaction recording system. |
| Connect: | This option is used to connect to the WebLogic EJB server. |
| Connect to | This option prompts user for the server connection |
| server: | parameters. |
| Record: | This option allows user to add new steps to the currently |
| | active control flow. |
| Start | This option initializes the control flow recording and is |
| Recording: | used to begin recording. |
| Add new | This option starts the wizard that adds a new step at the |
| step: | end of the active control flow. |
| Play: | This option is used to access functions that play all or |
| | part of a prerecorded control flow. |
| Play | This option plays the currently active control flow from |
| Recording: | beginning to end. |
| Play Step: | This option plays only the next step in the currently active |
| | control flow. |

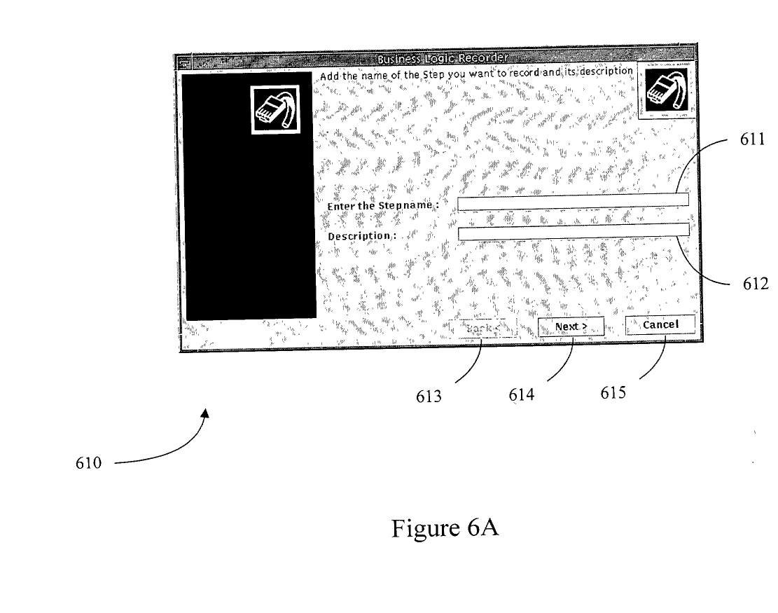

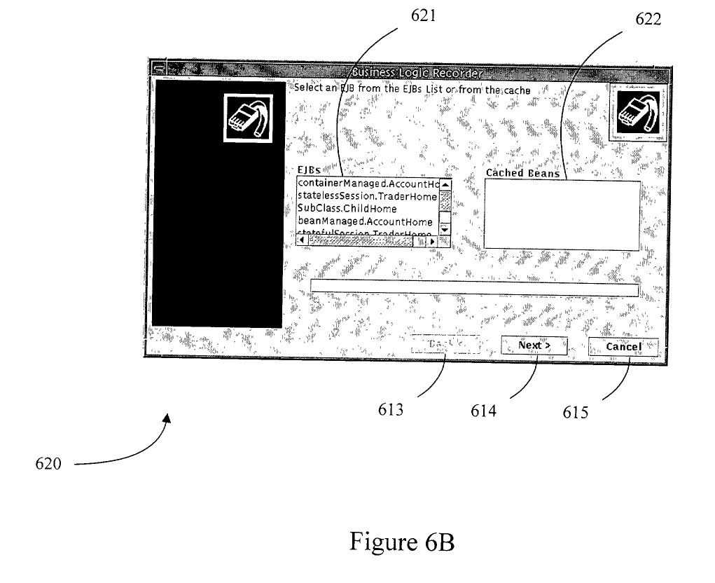

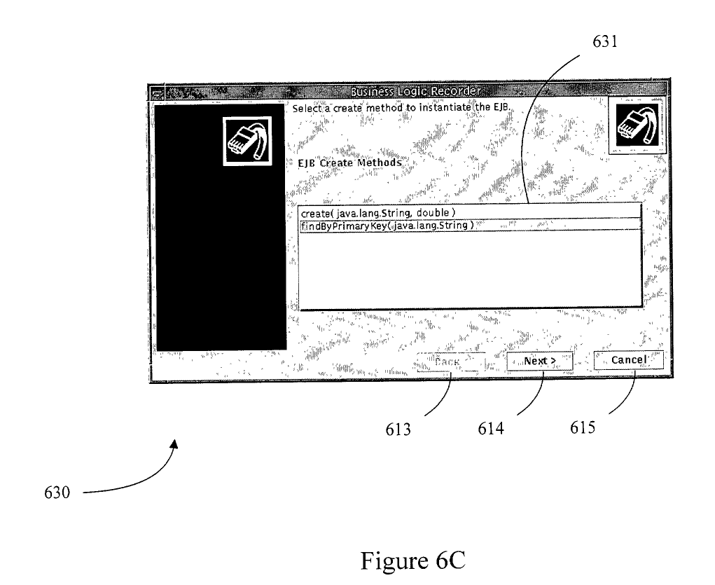

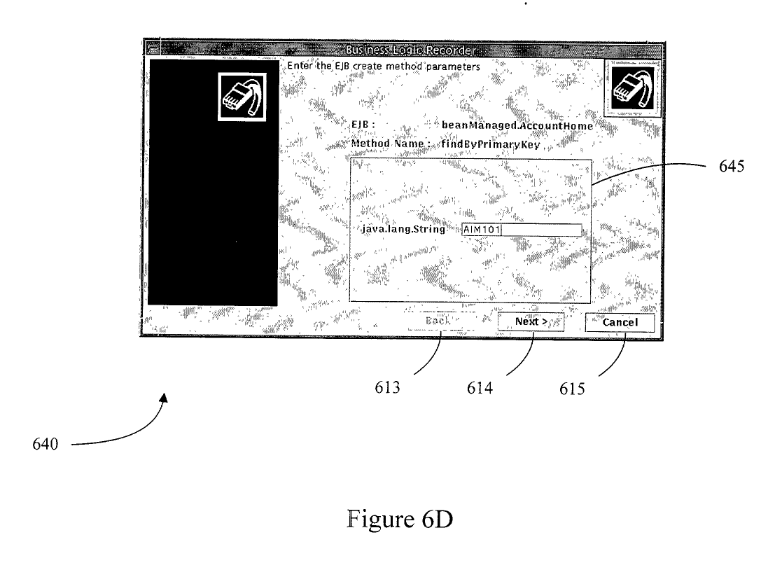

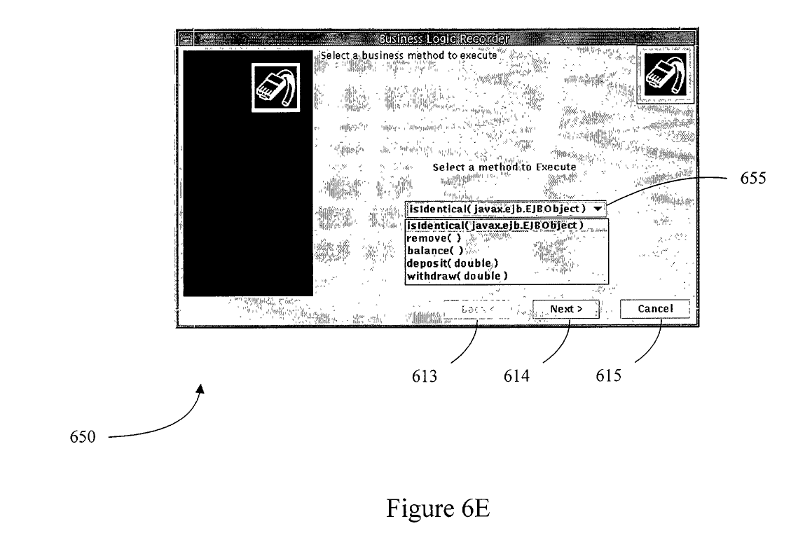

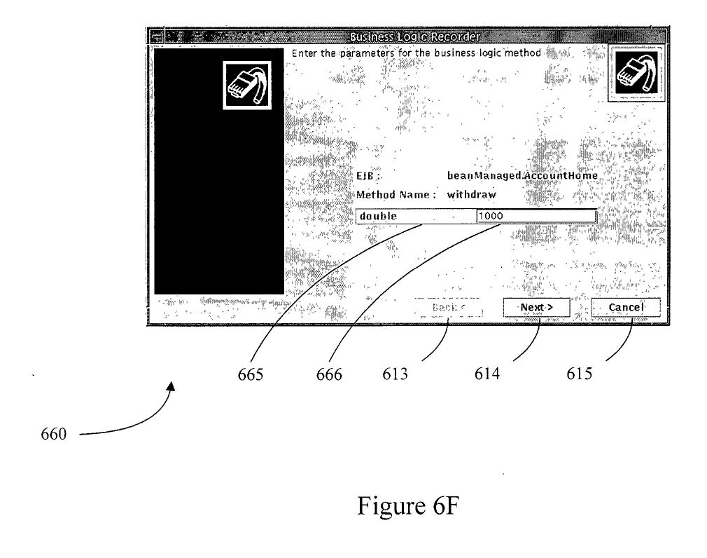

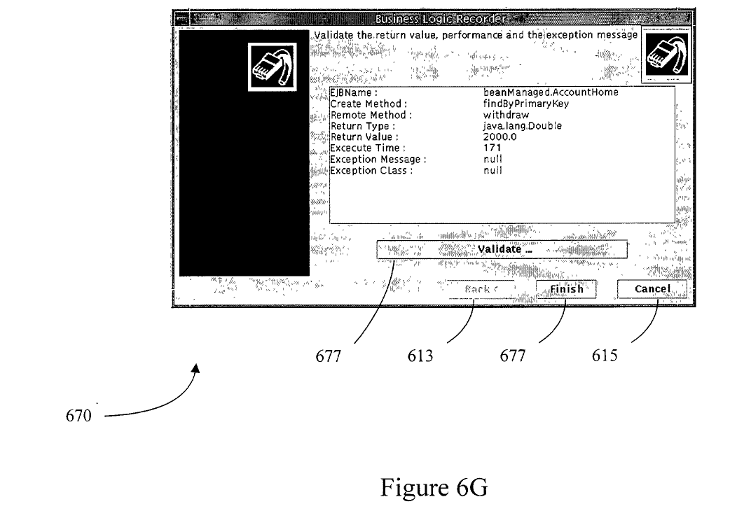

Each recorded control flow may be made up of one or more individual steps, or portions of a session. Referring now to FIGS. 6A-6G, there are illustrated the windows presented by the recording module when adding a single step to a control flow. The successive windows are presented in a “wizard” format that assists the user to record single step of a control flow. In each window, the user enters data and selects “Next” button 614 in order to proceed, “Back” button 613 to edit previously entered selections or “Cancel” button 615 to terminate the wizard.

FIG. 6A depicts a window 610 that allows the user to define a name 611 associated with the step to be recorded. The user may also provide a textual description 612 of the step.

FIG. 6B depicts a window 620 that presents user with the available EJB's in the server associated with the control flow. The user may select an unused EJB from selection window 621 or any EJB already in use in the control flow from selection window 622. Any EJB's already in use in the control flow are presented as ‘Cached Beans’ in selection window 622.

FIG. 6C depicts a window 630 that enables the user to select the EJB method to be used to create and/or find Java Bean instances. The user selects an EJB method from selection window 631.

FIG. 6D depicts a window 640 that enables the user to define which parameters from window 645 are to be used by the create method, if any. The java type of each parameter is displayed for informational purposes.

FIG. 6E depicts a window 650 that enables the user to select a method to execute from drop-down selection menu 655.

FIG. 6F depicts a window 640 that enables the user to assign values to the parameters defined in window 640. The values are assigned using input window 666.

FIG. 6G depicts a window 670 that displays the execution results of the method previously defined by the user using windows 620, 630, 640 650 and 660. Window 670 also enables the user to define validation tests for the method results. The user selects “Validate . . . ” button 675 to define the validation tests, “Finish” button 677 to complete the addition of the step to the control flow, “Back” button 613 to edit previously entered selections or “Cancel” button 615 to abort the addition of the step.

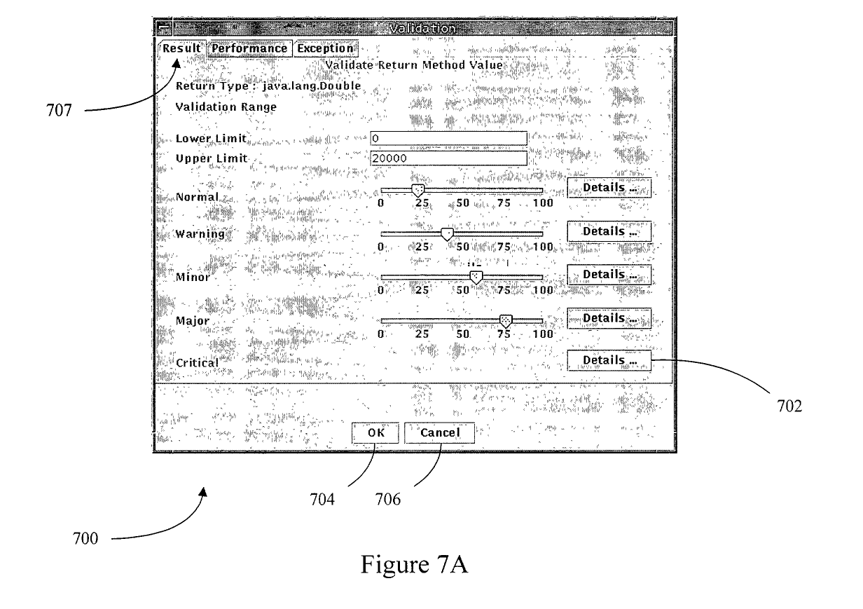

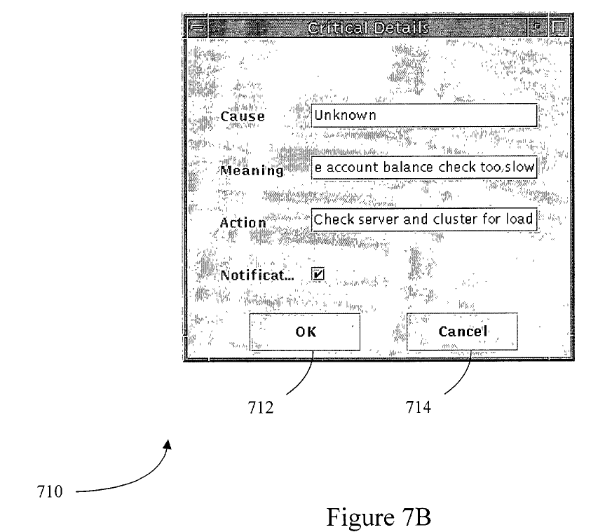

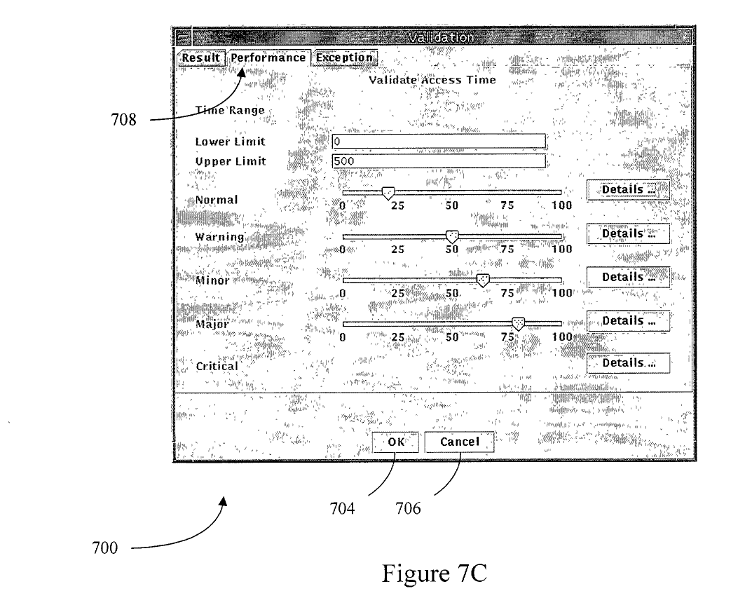

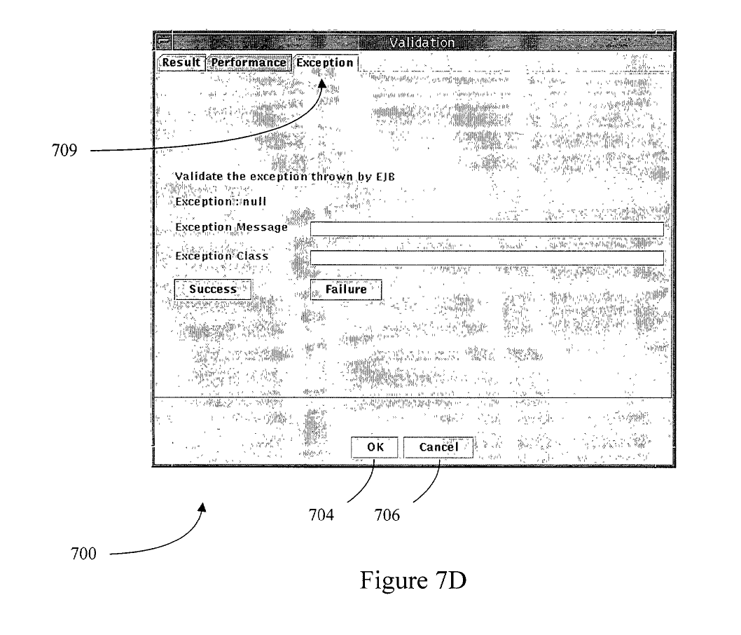

Referring now to FIGS. 7A-7D, if the user elects to define validation tests, the configuration module provides a series of windows to enable the user to define how the method results are validated. These windows enable the user to define validation based on three factors: 1) the actual return value of the method, if any; 2) the time taken to execute the method and 3) the exception raised by the method, if any. The validation can include a number of tests for each of the three factors.

FIG. 7A depicts validation window 700 having the “Result” tab 707 selected, enabling the user to define the validation of the result of the method. The example system supports return values of various types, including for example, strings, integer numbers and double integer numbers. When validating strings, the system compares a pre-defined pattern against a returned string value. When validating numbers, the system compares a pre-defined range of values against a returned numeric value.

Window 700 illustrated the validation definition for a double integer numeric value. In the illustrated example, a lower and upper limit to the overall validation range may be defined, as well as five categories within the range. Each category may be configured to provide a different alert message.

Each category has an associated “Details” button, such as button 702, which may be selected to define certain cause, meaning, action and notification parameters associated with the category. When the results fall within a particular category range, the associated parameters determine what notification, if any, to provide.

FIG. 7B depicts an example “Critical Details” window 720 which is presented if the user selects button 702 for the “Critical” range from window 700. When the returned result of a method parameter falls within the pre-defined critical range, the playback module refers to these parameters to determine any action to take. If the notification parameter 722 is selected, an alert notification will be delivered to a notification recipient's e-mail address or pager. The notification path is pre-defined and configured using the configuration module. The cause 724, meaning 726 and action 728 of the critical alert is incorporated into the alert message.

FIG. 7C depicts validation window 700 having the “Performance” tab 708 selected, enabling the user to define the validation of the performance of the method. The execution time observed during recording may be used as a benchmark to define an alarming level of performance. Specifically, if the execution of the method takes unexpectedly long, the administrators may need to be notified. The “Performance” tab 708 enables the user to define different levels of performance.

When validating performance, the system compares the access time for processing a method with the limits defined by the user using the “Performance” tab 708 of window 700. Like the “Result” tab 707, the “Performance” tab 708 enables the user to define an upper and lower limit to the range of access times, as well as five categories within the range. Each category has an associated “Details” button which enables the user to define any action that may be desired for the category.

FIG. 7D depicts validation window 700 having the “Exception” tab 709 selected, enabling the user to define the validation in the event an exception occurs during the processing of the method. Generally, exceptions indicate errors. Depending on the recording control flow, however, an exception may be expected. The exception validation can be used configure the status of the control flow based on the exception message. The configuration is similar to the string return value validation.

What has been described above includes several examples. It is, of course, not possible to describe every conceivable combination of components or methodologies for purposes of describing the systems, methods, and computer readable media associated with business process policy data. However, one of ordinary skill in the art may recognize that further combinations and permutations are possible. Accordingly, this application is intended to embrace such alterations, modifications, and variations that fall within the scope of the appended claims. Furthermore, to the extent that the term “includes” is employed in the detailed description or the claims, such term is intended to be inclusive in a manner similar to the term “comprising” as that term is interpreted when employed as a transitional word in a claim.

What is claimed is:

1. A method for monitoring interaction associated with a client-server application, comprising:
configuring recording, playback and analysis parameters;
recording control flow and server responses associated with the application;
replaying the control flow;
comparing server responses to the replayed control flow to recorded server responses to determine whether an alert condition exists; and
reporting the alert condition.

2. The method of claim 1, wherein configuring includes determining a playback interval, and replaying is performed at the playback interval.

3. The method of claim 1, wherein configuring includes determining alert conditions.

4. The method of claim 1, wherein configuring includes determining actions to be performed when reporting the alert condition.

5. The method of claim 1, wherein configuring includes determining at least one alert range.

6. The method of claim 1, wherein recording includes adding a step to a pre-recorded control flow.

7. The method of claim 1, wherein reporting includes constructing and transmitting an e-mail message describing the alert.

8. The method of claim 1, wherein reporting includes constructing and transmitting a pager message describing the alert.

9. A system for monitoring interaction associated with an application, comprising:
a configuration module for defining and storing configuration data;
a recording module for monitoring client-server interaction of the application and storing control data representing monitored client-server interaction in a store of control flow data;
a playback module for replaying client portions of stored control flow data and analyzing server responses to report an alert; and
a control module for controlling the configuration module, the recording module and the playback module.

10. The system of claim 9, wherein the configuration module is operative to determine a playback interval, and the playback module is operative to replay the control flow at the playback interval.

11. The system of claim 9, wherein the configuration module is operative to define alert conditions.

12. The system of claim 9, wherein the configuration module is operative to define actions to be performed when reporting the alert condition.

13. The system of claim 9, wherein the configuration module is operative to define at least one alert range.

14. The system of claim 9, wherein the recording module is operative to add a step to a pre-recorded control flow.

15. The system of claim 9, wherein the playback module is operative to construct and transmit an e-mail message describing the alert.

16. The system of claim 9, wherein the playback module is operative to construct and transmit a pager message describing the alert.

17. A system for monitoring interaction associated with an application, comprising:
means for defining and storing configuration data;
means for monitoring client-server interaction of the application and storing control data representing monitored client-server interaction;
means for replaying client portions of stored control flow data;
means for and analyzing server responses; and
means for reporting an alert based on the server responses.

18. A computer-readable storage medium encoded with processing instructions for monitoring interaction associated with a client-server application, including:
computer readable instructions for configuring recording, playback and analysis parameters, including determining a playback interval;
computer readable instructions for recording control flow and server responses associated with the application;
computer readable instructions for replaying the control flow at the playback interval;
computer readable instructions for comparing server responses to the replayed control flow to recorded server responses to determine whether an alert condition exists; and
computer readable instructions for reporting the alert condition.
